(19) United States
(12) Patent Application Publication
(10) Pub. No.: US 2002/0169886 A1
(43) Pub. Date: Nov. 14, 2002

(54) Communication device and communication control device for enabling operation of control protocol for one network on other types of networks

(75) Inventors: Takeshi Saito, Tokyo (JP); Keiichi Teramoto, Kanagawa (JP); Nobuyuki Monma, Kanagawa (JP); Hiroyuki Aizu, Kanagawa (JP); Shuichi Kyuma, Chiba (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/125,478

(22) Filed: Apr. 19, 2002

(30) Foreign Application Priority Data
Apr. 20, 2001 (JP) P2001-122916
Aug. 24, 2001 (JP) P2001-254947

(51) Int. Cl. G06F 15/16

(52) U.S. Cl. 709/230; 709/238; 709/245

(57) ABSTRACT

In order to make it possible to enable the operation of a control protocol such as Echonet on networks such Bluetooth, IP, etc., a communication control device carries out a routing processing according to an address table that stores in correspondence a Bluetooth address and a slave identifier of a Bluetooth, and an Echonet address of an Echonet protocol, for example. Also, a communication device carries out a transmission/reception processing of an IP packet according to an address table that stores in correspondence an IP address of the Internet protocol and an Echonet address of the Echonet protocol, for example.

### BACKGROUND OF THE INVENTION

1. Field of the Invention

The present invention relates to a communication control device/method and a communication device/method for enabling the operation of a control protocol such as Echonet on networks such as Bluetooth, IP, etc.

2. Description of the Related Art

In recent years, the information home electronics have been developing rapidly. This field encompasses a wide variety of devices such as home appliances, AV home electronics, information devices or mobile devices such as PCs, etc., and various applications utilizing the digital technology have been proposed for each device.

One such application is the use of a home network. The home network is a network technology developed for a network inside the home, for interconnecting various information home electronics mentioned above.

As this home network technology, the radio network technology has been attracting much attentions recently. various radio network technologies designed for home use such as 802.11a/b, Bluetooth, etc., have been proposed, developed, and sold. In particular, the Bluetooth has features of low cost and low power consumption so that it is expected to be supported by the wide range of devices such as the portable telephone, PC, PDA, home appliances, etc. For this reason, various devices equipped with the Bluetooth communication function are expected to appear in the market.

On the other hand, one exemplary application of the home network is a facility related network, or the use of the home network for the home automation. It is possible to connect air conditioners, lights, home appliances, etc., to the home network and carry out applications such as device state monitoring, remote controlling, etc.

In Japan, the Echonet is expected to be the de facto standard for this facility related network.

The Echonet is standardized by a consortium founded mainly by several Japanese electronics companies, which has already issued the specification version 1, and the commercial application is about to start.

For the home appliances, the installation of the Bluetooth communication interface can be attractive for the following reasons.

It becomes possible to make connections with a variety of devices such as portable telephones, AV devices, etc., so that the interactions between these devices and the facility related devices become possible.

The Bluetooth is a communication interface with relatively high functionality so that, apart from simple applications such as the remote monitoring and the remote controlling, it becomes possible to realize applications such as the AV data transfer for audio data or video data, and the Internet access.

The Bluetooth is a low cost communication interface so that it is suitable for the installation to the home electronics devices.

However, the Bluetooth is a network scheme which simultaneously uses a plurality of address systems such as “bluetooth address” and “slave identifier”, and there is no established method for operating the Echonet protocol on the Bluetooth (Echonet on Bluetooth).

Similarly, there is no established method for operating the Echonet protocol on the other networks such as IP.

### BRIEF SUMMARY OF THE INVENTION

It is therefore an object of the present invention to provide a communication control device/method and a communication device/method for enabling the operation of a control protocol such as Echonet on networks such Bluetooth, IP, etc.

According to one aspect of the present invention there is provided a communication control device for carrying out a communication control to support communications by a prescribed control protocol on a prescribed network with respect to a communication device having a function for accessing a prescribed network, the communication control device comprising: an interface unit configured to access the prescribed network; a control protocol processing unit configured to carry out a processing regarding data of the prescribed control protocol to be transmitted/received through the prescribed network; a memory unit configured to store in correspondence a first address information to be used in the prescribed network which is uniquely assigned to the communication device, an identification information to be assigned to the communication device by the communication control device for enabling identification of a logical connection in the prescribed network, and a second address information to be used by the prescribed control protocol which is assigned to the communication device by the communication control device, for each communication device connected to the prescribed network; and a routing processing unit configured to send data received through the prescribed network to the control protocol processing unit when received data are the data of the prescribed control protocol and a destination address of the received data is the communication control device, or obtain the identification information stored in the memory unit by using the destination address as the first address information and transmit the received data to the destination address through the logical connection in the prescribed network as specified by the identification information when the destination address is the communication device.

According to another aspect of the present invention there is provided a communication control method of a communication control device for carrying out a communication control to support communications by a prescribed control protocol on a prescribed network with respect to a communication device having a function for accessing a prescribed network, the communication control method comprising: storing in correspondence a first address information to be used in the prescribed network which is uniquely assigned to the communication device, an identification information to be assigned to the communication device by the communication control device for enabling identification of a logical connection in the prescribed network, and a second address information to be used by the prescribed control protocol which is assigned to the communication device by the communication control device, for each communication device connected to the prescribed network, as an address table; and sending data received through the prescribed network to a control protocol processor for carrying out a processing regarding data of the prescribed control protocol when received data are the data of the prescribed control protocol and a destination address of the received data is the communication control device, or obtaining the identification information stored in the address table by using the destination address as the first address information and transmitting the received data to the destination address through the logical connection in the prescribed network as specified by the identification information when the destination address is the communication device.

According to another aspect of the present invention there is provided a computer program product for causing a computer to function as a communication control device for carrying out a communication control to support communications by a prescribed control protocol on a prescribed network with respect to a communication device having a function for accessing a prescribed network, the computer program product comprising: a first computer program code for causing the computer to provide an interface function for accessing the prescribed network; a second computer program code for causing the computer to provide a control protocol processing function for carrying out a processing regarding data of the prescribed control protocol to be transmitted/received through the prescribed network; a third computer program code for causing the computer to provide a memory function for storing in correspondence a first address information to be used in the prescribed network which is uniquely assigned to the communication device, an identification information to be assigned to the communication device by the communication control device for enabling identification of a logical connection in the prescribed network, and a second address information to be used by the prescribed control protocol which is assigned to the communication device by the communication control device, for each communication device connected to the prescribed network; and a fourth computer program code for causing the computer to provide a routing processing function for sending data received through the prescribed network to the control protocol processing function when received data are the data of the prescribed control protocol and a destination address of the received data is the communication control device, or obtaining the identification information stored by the memory function by using the destination address as the first address information and transmitting the received data to the destination address through the logical connection in the prescribed network as specified by the identification information when the destination address is the communication device.

According to another aspect of the present invention there is provided a communication device for carrying out communications by a prescribed control protocol on a prescribed network of a prescribed network layer protocol, comprising: an interface unit configured to access the prescribed network; a control protocol processing unit configured to carry out a processing regarding data of the prescribed control protocol to be transmitted/received through the prescribed network; a memory unit configured to store in correspondence a network layer address with an address scope set to be link local which is to be used by each communication device in the prescribed network and a prescribed address to be used in the prescribed control protocol by each communication device, for each one of the communication device and other communication devices connected to the prescribed network; and a transmission/reception unit configured to carry out transmission/reception of a specific packet of the prescribed network layer protocol in which a packet of the prescribed control protocol is encapsulated, by using link local addresses as a destination network layer address and a source network layer address of the specific packet, according to the memory unit.

According to another aspect of the present invention there is provided a communication method of a communication device for carrying out communications by a prescribed control protocol on a prescribed network of a prescribed network layer protocol, the communication method comprising: storing in correspondence a network layer address with an address scope set to be link local which is to be used by each communication device in the prescribed network and a prescribed address to be used in the prescribed control protocol by each communication device, for each one of the communication device and other communication devices connected to the prescribed network, as an address table; and carrying out transmission/reception of a specific packet of the prescribed network layer protocol in which a packet of the prescribed control protocol is encapsulated, by using link local addresses as a destination network layer address and a source network layer address of the specific packet according to the address table.

According to another aspect of the present invention there is provided a computer program product for causing a computer to function as a communication device for carrying out communications by a prescribed control protocol on a prescribed network of a prescribed network layer protocol, the computer program product comprising: a first computer program code for causing the computer to provide an interface function for accessing the prescribed network; a second computer program code for causing the computer to provide a control protocol processing function for carrying out a processing regarding data of the prescribed control protocol to be transmitted/received through the prescribed network; a third computer program code for causing the computer to provide a memory function for storing in correspondence a network layer address with an address scope set to be link local which is to be used by each communication device in the prescribed network and a prescribed address to be used in the prescribed control protocol by each communication device, for each one of the communication device and other communication devices connected to the prescribed network; and a fourth computer program code for causing the computer to provide a transmission/reception function for carrying out transmission/reception of a specific packet of the prescribed network layer protocol in which a packet of the prescribed control protocol is encapsulated, by using link local addresses as a destination network layer address and a source network layer address of the specific packet, according to the memory function.

Other features and advantages of the present invention will become apparent from the following description taken in conjunction with the accompanying drawings.

### BRIEF DESCRIPTION OF THE DRAWINGS

FIG. 1 is a diagram showing an exemplary configuration of a home network system according to the first embodiment of the present invention.

FIG. 2 is a block diagram showing an exemplary configuration of an Echonet controller according to the first embodiment of the present invention.

FIG. 3 is a diagram showing an exemplary structure of an address table in the Echonet controller of FIG. 2.

FIG. 4 is a sequence chart for one exemplary overall sequence of the home network system of FIG. 1.

FIG. 5 is a diagram showing an exemplary format of an Echonet ARP packet according to the first embodiment of the present invention.

FIG. 6 is a sequence chart for another exemplary overall sequence of the home network system of FIG. 1.

FIG. 7 is a diagram showing an exemplary format of an encapsulated Echonet packet according to the first embodiment of the present invention.

FIG. 8 is a flow chart showing an exemplary processing procedure of an Ethernet frame routing unit in the Echonet controller of FIG. 2.

FIG. 9 is a sequence chart for an exemplary address resolution sequence of the home network system of FIG. 1.

FIG. 10 is a diagram showing an exemplary configuration of a home network system according to the second embodiment of the present invention.

FIG. 11 is a block diagram showing an exemplary configuration of an Echonet controller according to the second embodiment of the present invention.

FIGS. 12A and 12B are diagrams showing an exemplary structure of an address table in the Echonet controller of FIG. 11.

FIG. 13 is a sequence chart for one exemplary overall sequence of the home network system of FIG. 10.

FIG. 14 is a diagram showing an exemplary format of an Echonet ARP packet according to the second embodiment of the present invention.

FIG. 15 is a sequence chart for another exemplary overall sequence of the home network system of FIG. 10.

FIG. 16 is a flow chart showing an exemplary processing procedure of an Echonet address determination for an Echonet device according to the second embodiment of the present invention.

FIG. 17 is a sequence chart for another exemplary overall sequence of the home network system of FIG. 10.

FIG. 18 is a diagram showing an exemplary format of an encapsulated Echonet packet according to the second embodiment of the present invention.

FIG. 19 is a sequence chart for one exemplary address resolution sequence of the home network system of FIG. 10.

FIG. 20 is a sequence chart for another exemplary address resolution sequence of the home network system of FIG. 10.

### DETAILED DESCRIPTION OF THE INVENTION

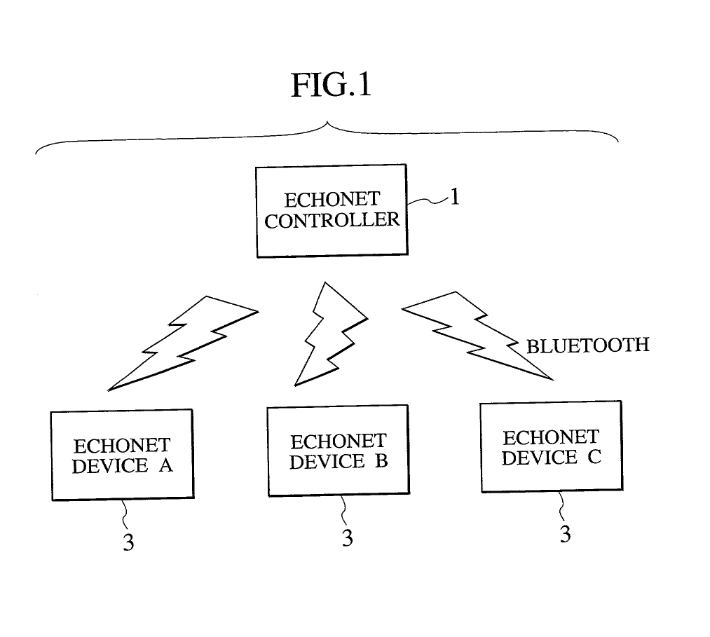

Referring now to FIG. 1 to FIG. 9, the first embodiment of a communication control device/method and a communication device/method according to the present invention will be described in detail.

This first embodiment is directed to the case of enabling the operation of the Echonet protocol on the Bluetooth by mapping the Echonet protocol onto the Bluetooth.

In this embodiment, the exemplary case of using a configuration for connecting various home appliances and their controllers by using the local radio network technology called Bluetooth. Here, the Bluetooth is a local radio network characterized by its low cost and low power consumption, and its further details can be found in documents disclosed at the URL “http://www.bluetooth.com”, for example. In the following, the Bluetooth may be abbreviated as BT whenever convenient.

FIG. 1 shows an exemplary configuration of the home network system in this embodiment.

As shown in FIG. 1, in this home network system, an Echonet controller 1 and a plurality (three in an example of FIG. 1) of Echonet devices 3 in the active mode are interconnected through the Bluetooth. The Echonet controller 1 has a function for controlling (or monitoring) the Echonet devices 3 through the Bluetooth. Note that, the home network of FIG. 1 may also be connected with the Echonet devices in the park mode or devices that do not support the Echonet.

Here, the Echonet is a specification for a facility related network, in which commands, protocols, objects, API, etc. for controlling facility related devices (home appliances, etc.) on various physical media such as electric power lines, twisted pair lines, etc. Further details of the Echonet can be found in documents disclosed at the URL “http://www.echonet.gr.jp”, for example. In this embodiment, this Echonet protocol is mapped onto the Bluetooth.

Note also that the Echonet devices 3 can be any devices including home appliances, AV devices, information devices such as PCs, as long as they support the Echonet.

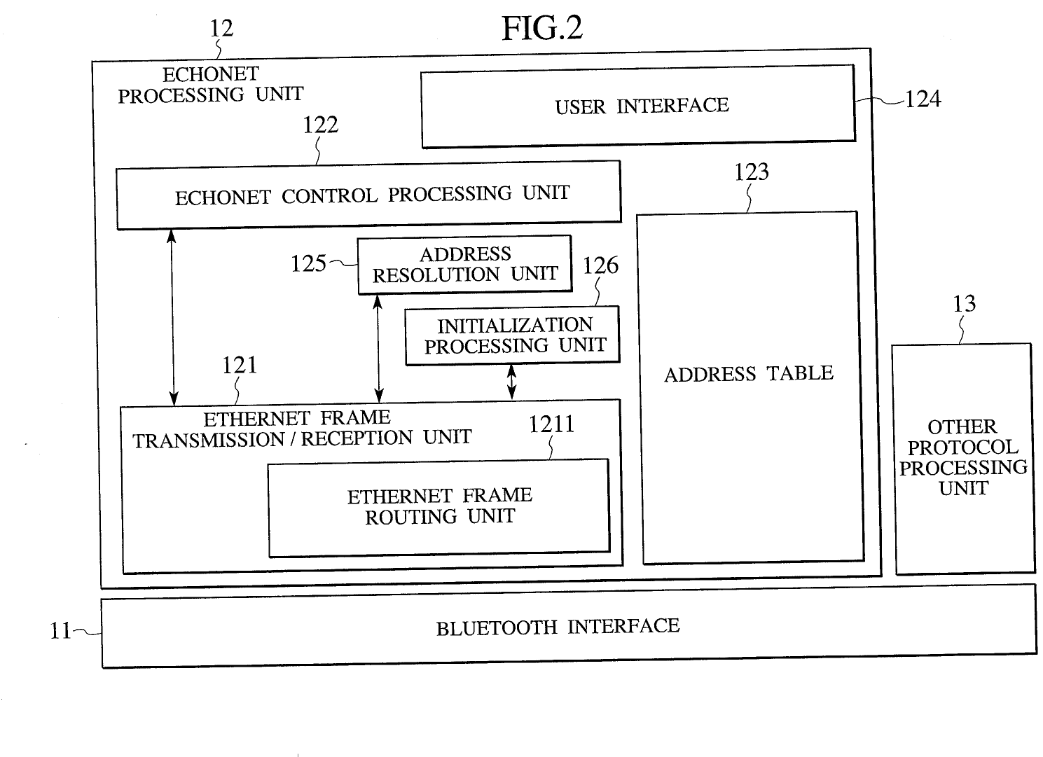

FIG. 2 shows an exemplary internal configuration of the Echonet controller 1.

As shown in FIG. 2, the Echonet controller 1 has a Bluetooth interface 11 for carrying out radio communications according to the Bluetooth, an Echonet processing unit 12 for carrying out the Echonet processing, and an other protocol processing unit 13 for carrying out prescribed protocol processing.

The Echonet processing unit 12 has an Ethernet frame transmission/reception unit 121 for carrying out transmission/reception of Ethernet frames with the Bluetooth interface 11, an initialization processing unit 126 for carrying out the initialization processing for the Echonet on Bluetooth, an address resolution unit 125 for carrying out the address resolution between the Echonet address and the Bluetooth address (BD_ADDR), an address table 123 for storing correspondences among the Bluetooth addresses, the slave identifiers (AM_ADDR) and the Echonet addresses (where a park slave identifier PM_ADDR will be stored instead of the slave identifier if the slave is in the park mode), an Echonet control processing unit 122 for carrying out the Echonet command processing and middleware processing in general, and a user interface 124 such as a liquid crystal screen, a touch panel, a keyboard, etc.

Also, the Ethernet frame transmission/reception unit 121 has an Ethernet frame routing unit 1211 for carrying out the routing of the Ethernet frames.

Here, the Echonet controller 1 is assumed to have the Bluetooth address “B₀” and the Echonet address “E₀”. The actual value of E₀ may be a fixed value such as 0 or 1. This setting is aimed at the simplification of the processing by fixedly assigning a special Echonet address a node in a position of the Bluetooth master, because such a node plays special roles (for carrying out the Ethernet frame routing, the address resolution, the initialization processing, etc.) as the Echonet node in the Bluetooth of this embodiment.

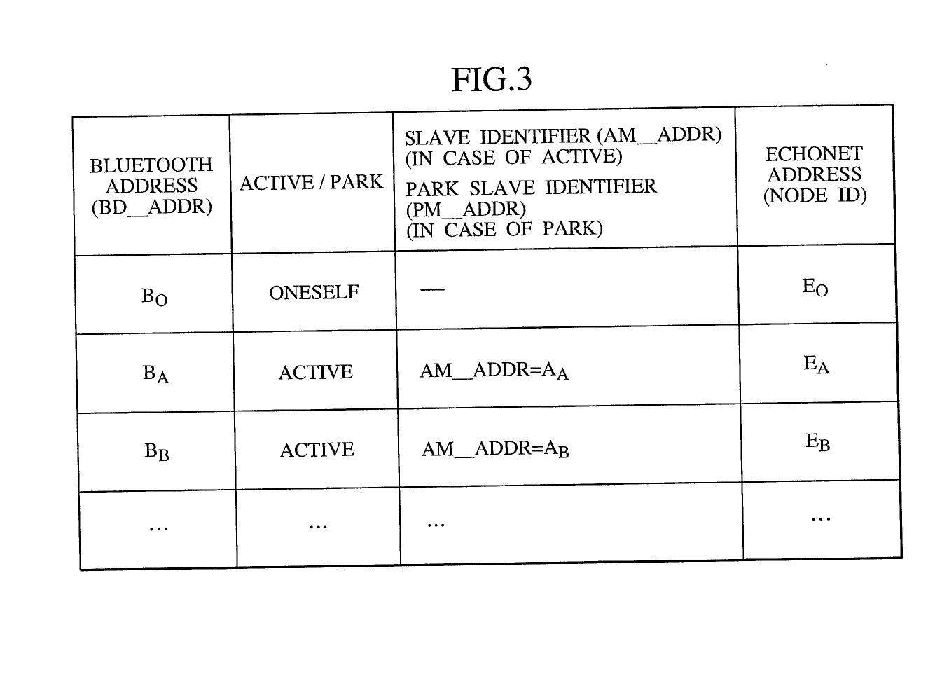

FIG. 3 shows an exemplary internal structure of the address table 123.

As mentioned above, the address table 123 stores the correspondences among the Bluetooth addresses, the slave identifiers and the Echonet addresses.

Here, the Bluetooth address is a fixed address of 48 bits length that is assigned at a time of the shipment of the product in a form of being stored in a ROM, whose uniqueness is guaranteed globally. The slave identifier (AM_ADDR) is an identifier of 3 bits length assigned to the Bluetooth device (slave) that is active (in a connected state) at that point. This identifier takes a logical value, and there is a possibility of having different values assigned depending on cases. The assignment of this value is carried out by the Bluetooth master (which is the Echonet controller 1 in this embodiment).

The Echonet address is a logical identifier of 8 bits length, which has a specification as defined in the Echonet specification. Note that the Echonet specification also defines a network identifier called net ID, but in this embodiment, it is assumed that the net ID is fixed and a node ID to be assigned individually to the node will be utilized. For this value, there is also a possibility of having different values assigned depending on cases.

Note that, in the example of FIG. 3, the subscript 0 indicates those corresponding to the Echonet controller 1 of FIG. 1, while the subscripts A and B indicate those corresponding to the Echonet devices A and B of FIG. 1, respectively.

Now, in the case of mapping the Echonet onto the Bluetooth, there is a need to define a method for mapping the Bluetooth address, the slave identifier and the Echonet address. In this embodiment, this mapping is appropriately carried out by the Echonet controller 1.

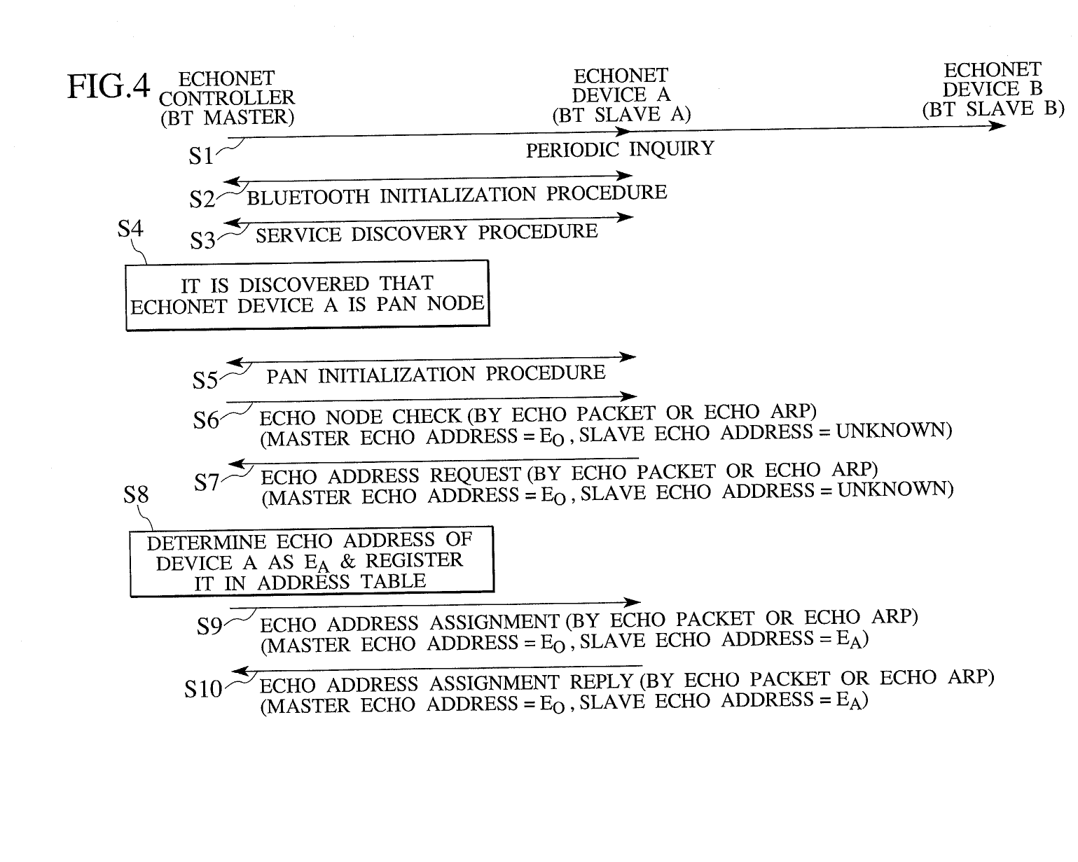

FIG. 4 shows one exemplary overall sequence for the case where the Echonet device 3 joins the Bluetooth piconet, the Echonet address is assigned, and the correspondence among addresses is established.

The Echonet controller 1 periodically sends an Inquiry to the surrounding (S1). This operation is carried out periodically so that the Echonet controller 1 can appropriately detect a presence of a device that is attempting to newly join the piconet in the surrounding.

Suppose now that the Echonet device A (of FIG. 1) is attempting to join this Bluetooth piconet so that the Echonet device A responds to this inquiry as a result of the above operation.

The Echonet controller 1 carries out the Bluetooth initialization procedure such as the procedure for Inquiry, Page, etc., with the Echonet device A, determines the slave identifier of the Echonet device A as “A_{A}” as a result of this operation and stores this slave identifier into the address table 123 (S2). At this point, the Echonet address of the Echonet device A is not determined yet.

Next, the service discovery procedure is carried out between the Echonet controller 1 and the Echonet device A (S3). Suppose now that the Echonet controller 1 discovers that the Echonet device A is a PAN (Personal Area Network) node through this procedure (S4). Here, the PAN is a specification for the Ethernet emulation defined on the Bluetooth. Using this mechanism, it becomes possible to carry out exchanges of the Ethernet frames on the Bluetooth.

The Echonet controller 1 that discovered that the correspondent node is a PAN node then carries out exchanges necessary for the PAN initialization with the Echonet device A (S5). Note that it is also possible to discover that the correspondent node is supporting the Echonet protocol at this point. In such a case, the protocol number indicating the Echonet will be discovered in the service discovery procedure.

Next, an “initialization sequence in the case of operating the Echonet on the Bluetooth” that is indispensable in making the Echonet node operable, such as a check to judge whether the correspondent is an Echonet node or not, an assignment of the Echonet address, etc., is carried out between the Echonet controller 1 and the Echonet device A. These messages may be exchanged by using the Echonet packets, but in this embodiment, these messages are assumed to be defined as messages of a protocol called Echonet ARP (Address Resolution Protocol) for intermediating the Echonet and the lower layer (Bluetooth in this embodiment).

The Echonet ARP is a protocol for intermediating between the Echonet protocol and the Ethernet protocol in the case of transferring the Echonet packet by the Ethernet frame. For example, the Echonet ARP has a function for revealing the correspondence between the Echonet address and the Ethernet address as will be described below. In this embodiment, this Echonet ARP is operated on the Bluetooth in a form of the Ethernet emulation, so that a special flag (or field) indicating that “this is a message applicable when the link layer is the Bluetooth” may be provided in the Echonet ARP packet.

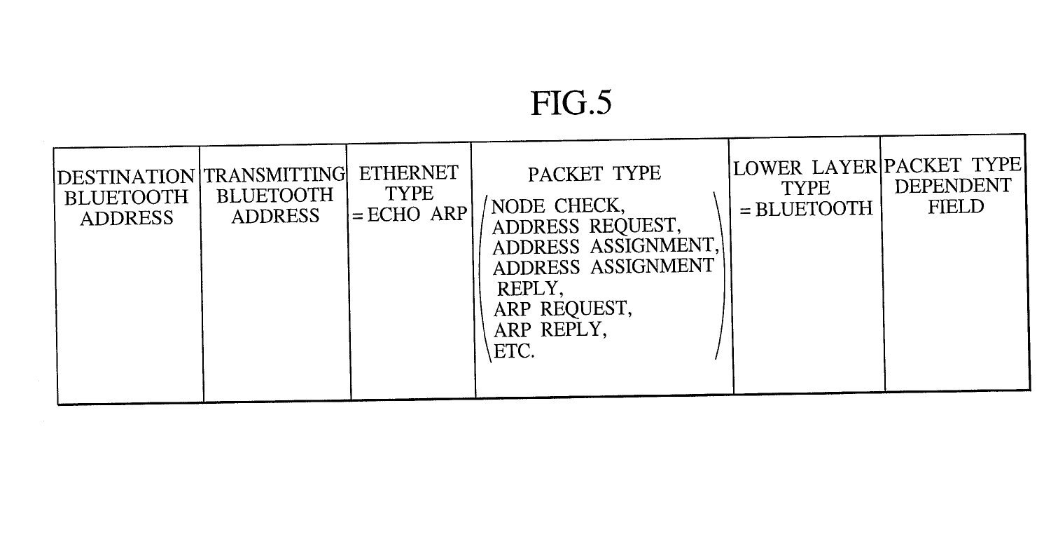

FIG. 5 shows an exemplary structure of the Echonet ARP packet. As shown in FIG. 5, the Echonet ARP packet is provided with fields for judging whether “the lower layer is the Bluetooth” or not. For example, in the case of the ordinary ARP packet, fields for describing “master side Echonet address”, “master side Ethernet address” (the Bluetooth address in this embodiment), “slave side Echonet address”, and “slave side Ethernet address” (the Bluetooth address in this embodiment) are provided. A part of these regions may be omitted.

Note that, in the example of FIG. 5, whether it is “Echonet” or “Echo ARP” is described in the Ethernet type (protocol identifier) of the Echonet packet or the Echo ARP packet, but it is also possible to use a format in which a value indicating that it is a packet of the Echonet protocol is described in the Ethernet type, and whether it is “Echonet” or “Echo ARP” is described in the packet type.

Next, the Echonet controller 1 transmits an Echo node check which is a message for checking whether the correspondent device (the Echonet device A) supports the Echonet protocol or not (S6). At this point, the Echonet controller 1 has not recognized that the Echonet device A is an Echonet device (or even if that fact is already recognized, the address is still not assigned), so that the Echonet controller 1 describes the own Echonet address “E₀” in that message but does not describe the Echonet address of the correspondent side (the Bluetooth slave side) and inserts a value indicating that it is indeterminate.

In response, as a reply from the Echonet device A, an Echonet address request which is a message indicating that “this device supports the Echonet protocol” and that “assignment of the Echonet address to this device is requested” is transmitted to the Echonet controller (the Bluetooth master) 1 (S7).

Then, the Echonet controller 1 obtains a value of the Echonet address that is still unused (calculates E_{A} in this embodiment) by referring to the address table 123 provided therein, and registers this value into the address table 123 as the Echonet address of the Echonet device A (S8).

The Echonet controller 1 then transmits a message loaded with the Echonet address “E_{A}” to be assigned to the slave (the Echonet device A) as an Echonet address assignment message to the Echonet device A (S9).

Upon receiving this message, the Echonet device A returns an Echonet address assignment reply message to the Echonet controller 1 in order to indicate that “the assignment of the Echonet address “E_{A}” is confirmed” (S10).

Upon receiving this message, the Echonet controller 1 ascertains that the Echonet address “E_{A}” is assigned to the Echonet device A, and confirms the registration of this fact in the address table 123 provided therein (or cancel the registration if this fact cannot be ascertained). At this point, the address table 123 has registered the correspondence among the Bluetooth address, the slave identifier, and the Echonet address of the Echonet device A. Among them, the slave identifier (or the park slave identifier in the case where the slave is in the park mode) and the Echonet address are to be assigned by the Echonet controller 1 which is the Bluetooth master. This is because, in the case of the Bluetooth, all the communications are to be carried out via the master device and the processing is centralized to the master device so that it is appropriate to provide the address assignment function at the master device.

By repeating the above sequence, the assignment of the Echonet address is carried out with respect to a plurality of Echonet devices to be connected to this Bluetooth piconet.

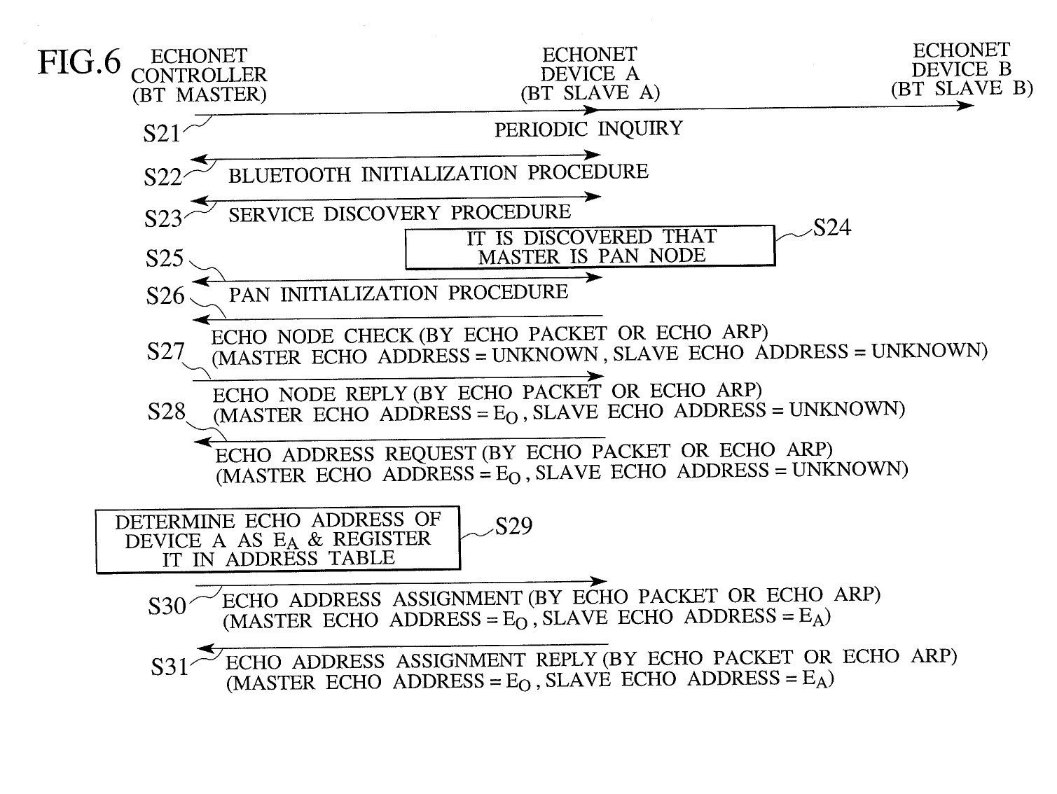

Next, FIG. 6 shows another exemplary overall sequence for the case where the Echonet device 3 joins the Bluetooth piconet, the Echonet address is assigned, and the correspondence among addresses is established.

Similarly as in the exemplary sequence of FIG. 4, the Echonet controller 1 periodically sends an Inquiry to the surrounding (S21), and the Echonet controller 1 carries out the Bluetooth initialization procedure (S22) and the service discovery procedure (S23) with the Echonet device A. Here, a difference from FIG. 4 is that the Echonet device A side discovers that the Bluetooth master is a PAN node (S24) and carries out the PAN initialization procedure (S25), and the checking as to whether it is an Echonet node or not and the request for the assignment of the Echonet address are made from the slave device side.

When the PAN initialization procedure (S25) is finished, the Echonet device A transmits an Echo node check message in order to check whether the master device supports the Echonet protocol or not (S26). In response, upon receiving this message, the Echonet controller 1 transmits an Echo node reply message for replying that this device is the Echonet node (S27). Here, however, the Echonet address of the Echonet device A has not been determined at this point yet, so that a character string indicating “indeterminate” is inserted into a field to which the Echonet address of the slave (Echonet device A) side is to be entered.

Next, upon checking that the correspondent (the Bluetooth master) is the Echonet device, the Echonet device A transmits a message for requesting the assignment of the Echonet address to the Echonet controller 1 (S28). The subsequent sequence (S29 to S31) are the same as in the case of FIG. 4.

By repeating the above sequence, the assignment of the Echonet address is carried out with respect to a plurality of Echonet devices to be connected to this Bluetooth piconet.

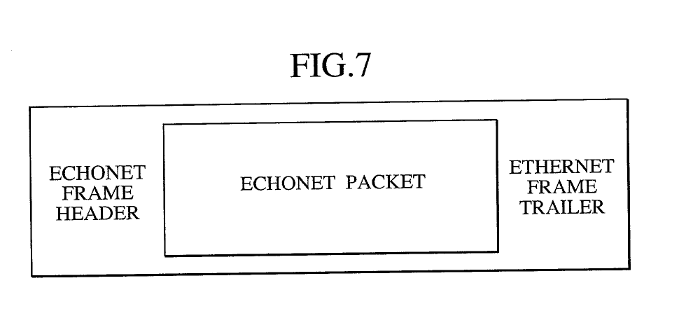

As mentioned above, in this embodiment, the Echonet packet is transferred by being encapsulated in the Ethernet frame. FIG. 7 shows a form of this Echonet packet as encapsulated in the Ethernet frame. Consequently, in the case of the Echonet packet to be transmitted from the Echonet device A to the Echonet device B, for example, the Echonet packet has a transmitting address “E_{A}” and a receiving address “E_{B}” as the Echonet packet, while the Ethernet frame has a source address “B_{A}” and a destination address “B_{B}” (but in the case of transferring it over the Bluetooth, these fields may possibly be omitted).

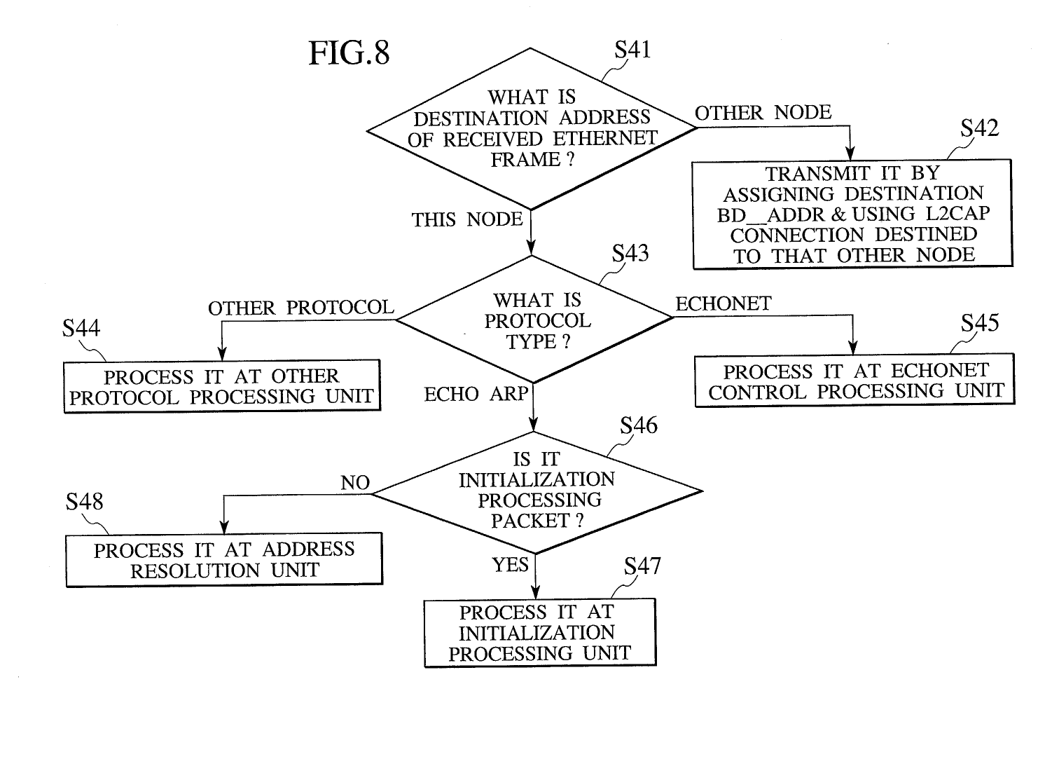

However, in the case of transferring packets over the Bluetooth, the packets will be transmitted in forms of the Bluetooth packets, so that the communications are limited only between the master and the slave. For this reason, the master node will judge the destination addresses (the destination Bluetooth addresses) of these received packets and carries out the routing. This routing of the Ethernet frames is carried out by the Ethernet frame routing unit 1211. FIG. 8 shows an exemplary processing of the Ethernet frame routing unit 1211.

When the Ethernet frame is received through the Bluetooth packet, the Echonet controller (the Bluetooth master) 1 checks whether the received Ethernet frame is destined to the Echonet controller 1 itself or not (S41). If it is not destined to the Echonet controller 1 itself, the Echonet controller 1 refers to the address (B_{A}, for example) indicated in the destination Ethernet address (the destination Bluetooth address), checks the slave identifier of that node by referring to the address table 123, and transmits the received Ethernet frame by attaching the destination BD_ADDR and using the L2CAP channel connected to that slave (S42).

If the received Ethernet frame is destined to the Echonet controller 1 itself, the Echonet controller 1 judges the protocol type of that packet as an Echonet, an Echonet ARP, or the other protocol, by referring to the Ethernet type field (S43).

If it is a packet of the other protocol, that packet is transferred to the other protocol processing unit 13 (S44).

If it is an Echonet packet, that packet is transferred to the Echonet control processing unit 122 (S45).

If it is an Echonet ARP packet, whether that packet is a packet (ARP packet) requesting the address resolution or a packet requesting the initialization processing (for example, the echo node check message, the echo node reply message, the Echo address request message, the Echo address assignment message, or the Echo address assignment reply message of this embodiment) is judged (S46).

If it is a packet requesting the initialization processing, this packet is transferred to the initialization processing unit 126 (S47). The processing of the initialization processing unit 126 is as already described above.

If it is a packet requesting the address resolution, this packet is transferred to the address resolution unit 125 (S48).

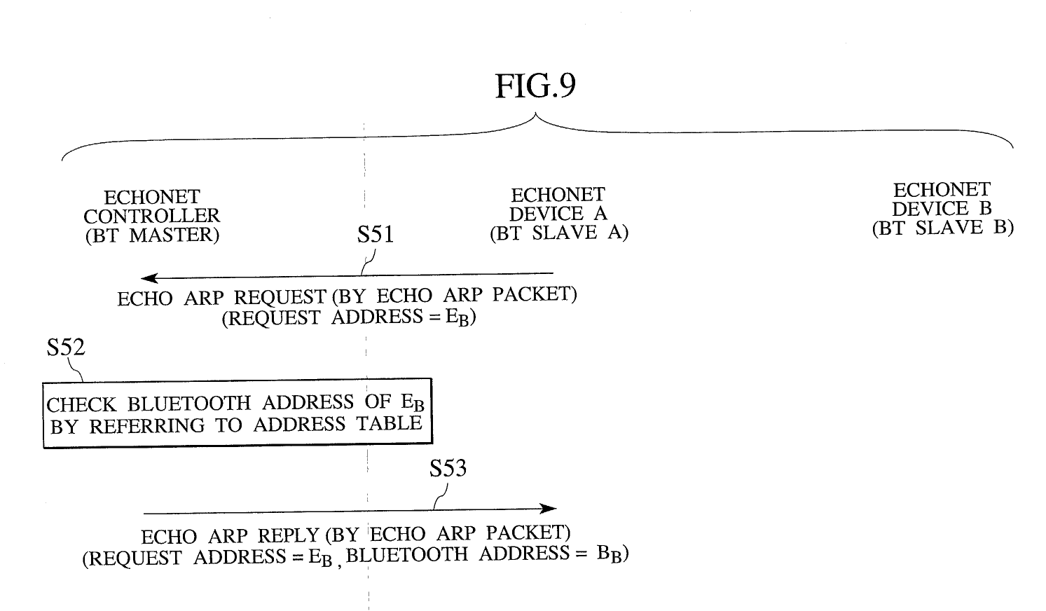

FIG. 9 shows an exemplary sequence for the address resolution.

FIG. 9 is directed to the case where the Echonet controller (the Bluetooth master) 1 becomes the address resolution server and resolves the address by referring to the address table 123 provided therein.

For example, when the Echonet device A wishes to resolve the Bluetooth address of the Echonet device B from the Echonet address of the Echonet device B, the Echonet ARP request packet is transmitted in a form of a unicast packet to the Echonet controller 1 (S51). At that point, “E_{B}” is attached as the address whose resolution is requested.

Upon receiving this packet, the Echonet controller 1 checks the Bluetooth address of “E_{B}” by referring to the address table 123 provided therein (S52), and ascertains that it is “B_{B}”.

The Echonet controller 1 then returns the Bluetooth address “B_{B}” of the Echonet device B as the Echonet ARP reply (S53).

Thereafter, when there is a packet destined to the Echonet device B, the Echonet device A transmits the Ethernet frame with the destination Bluetooth address “B_{B}” to the Echonet controller 1. In this way, the communications between arbitrary Echonet devices can be realized.

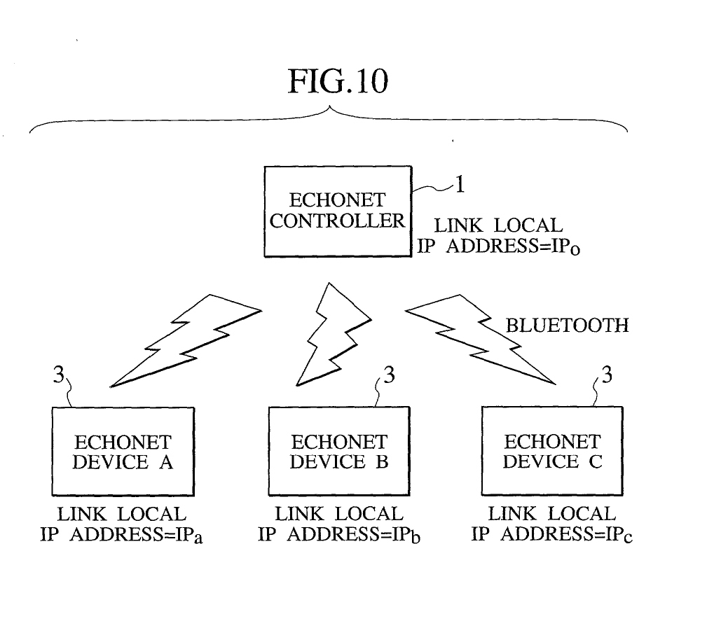

Referring now to FIG. 10 to FIG. 20, the second embodiment of a communication control device/method and a communication device/method according to the present invention will be described in detail.

This second embodiment is directed to the case of enabling the operation of the Echonet protocol on the IP network by mapping the Echonet protocol onto the IP (which can be either IPv4 or IPv6). Note that, on the Bluetooth, the “IP over Bluetooth” method is defined as the profile of PAN (Personal Area Network), and the use of this method is also assumed in this embodiment. In the following, the difference from the first embodiment will be mainly described.

FIG. 10 shows an exemplary configuration of the home network system in this embodiment.

As shown in FIG. 10, in this home network system, an Echonet controller 1 and a plurality (three in an example of FIG. 10) of Echonet devices 3 are interconnected through the Bluetooth. The Echonet controller 1 has a function for controlling (or monitoring) the Echonet devices 3 through the Bluetooth.

Each one of the Echonet controller 1 and the Echonet devices 3 has an IP address. The IP address can be either an IPv4 address or an IPv6 address, but it is assumed to be a link local address. The link local address is a special IP address, which can be used only on that link (which is the Bluetooth (but there can be cases where a reachable range of the Ethernet packet is to be included) in this embodiment). This is a scheme in which there is no need to give a global unique IP address, which is used in the case of operating specific application of the IP on a local network (link network).

The Echonet is a “protocol for which accesses (to the home appliances, for example) from the external of the link (i.e., the user's home, for example). Namely, the Echonet protocol is a protocol developed by presupposing the local network as its target, so that it is preferable to use the link local address even on the IP, while it is possible to prevent erroneous accesses or malicious accesses to the Echonet operating range and the home appliances from outside of the home. To this end, the Echonet packets transferred from regions other than the link local address can be invalidated.

Note also that the Echonet devices 3 can be any devices including home appliances, AV devices, information devices such as PCs, as long as they support the Echonet, similarly as in the first embodiment.

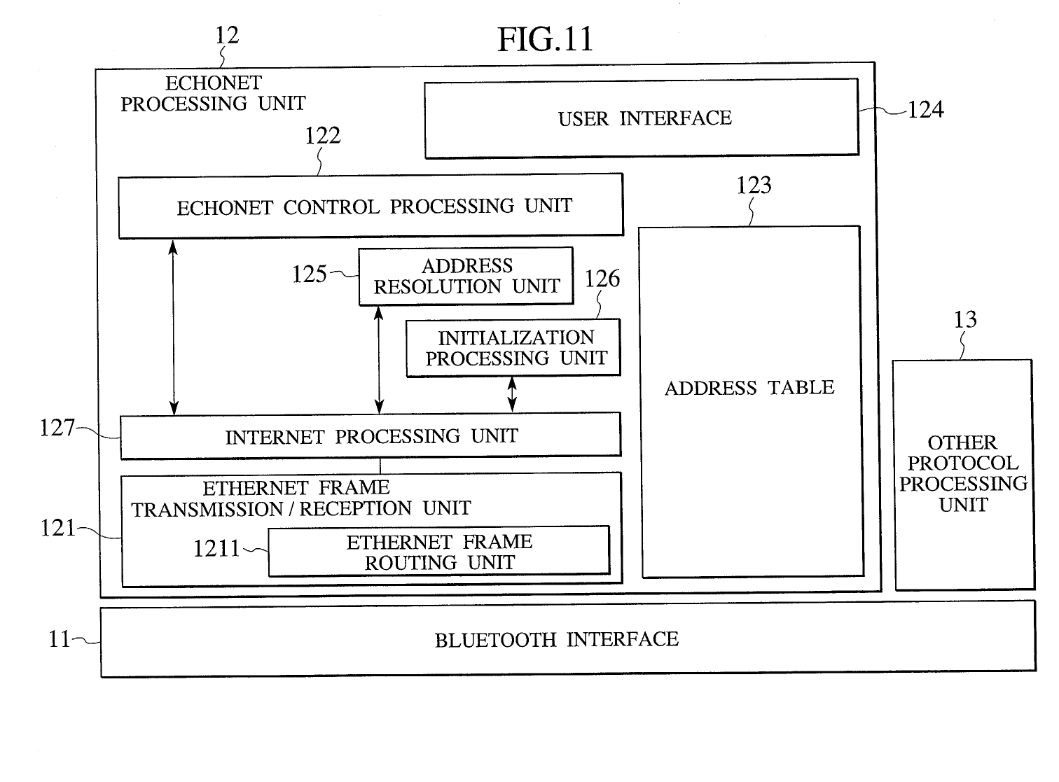

FIG. 11 shows an exemplary internal configuration of the Echonet controller 1.

The difference between the first embodiment and the second embodiment is that an Internet processing unit 127 is provided because the existence of the IP is presupposed, and the address table 123 is provided in a form of a correspondence table for the IP address and the Echonet address. Note that the echonet device 3 of this embodiment has the internal configuration basically similar to that of the Echonet controller 1 of this embodiment.

Note also that, in this embodiment, the Echonet controller 1 is provided in a position of the Bluetooth master, but it may be provided in a position of the slave (such as any of the positions of the Echonet devices 3 of FIG. 10, for example) in practice.

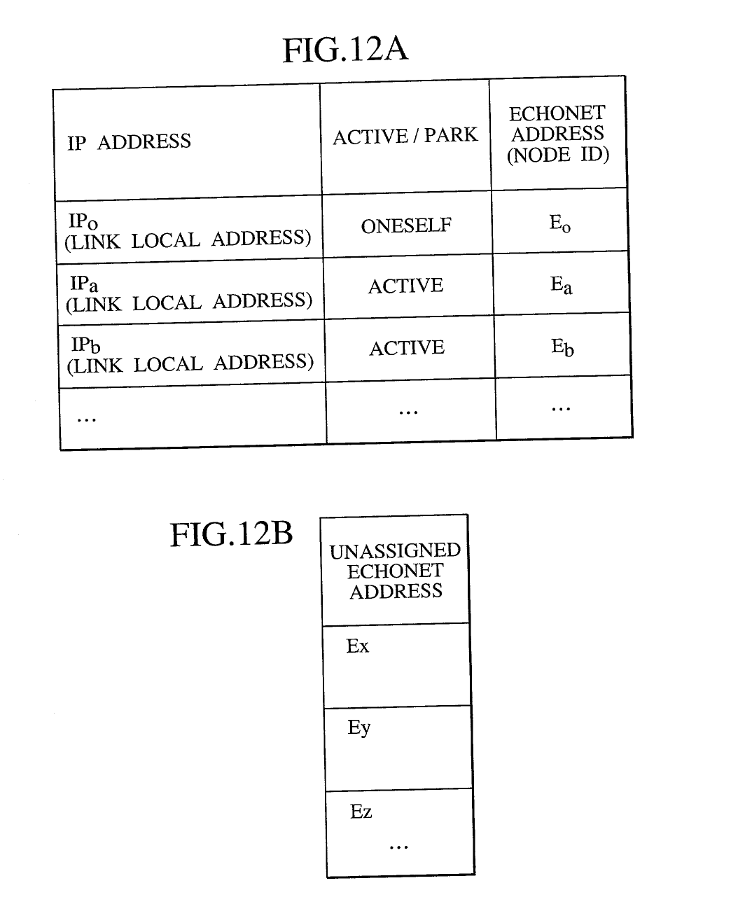

Next, FIGS. 12A and 12B show an exemplary internal structure of the address table 123.

As shown in FIG. 12A, the address table 123 of this embodiment stores the correspondences among the IP address (the link local address in this embodiment) of the Echonet node located in that IP subnet (more specifically, in that link local space), information regarding whether that node is in the active mode or the park mode on the Bluetooth, and (a node ID of) the Echonet address.

Also, the Echonet controller 1 is provided with a function for “assigning an Echonet address to an Echonet node that newly appeared in the subnet”, and to this end, as shown in FIG. 12B, the address table 123 may also have “a list of Echonet addresses that are not assigned at that point” as a part of the information of the address table 123.

Here, as described above, the Echonet address is a logical identifier of 8 bits length, which has a specification as defined in the Echonet specification. Note that the Echonet specification also defines a network identifier called net ID, but in this embodiment, it is assumed that the net ID is fixed and a node ID to be assigned individually to the node will be utilized. For this value, there is also a possibility of having different values assigned to the same node depending on cases.

Note that, in the example of FIG. 12A, the subscript 0 indicates those corresponding to the Echonet controller 1 of FIG. 10, while the subscripts A and B indicate those corresponding to the Echonet devices A and B of FIG. 10, respectively.

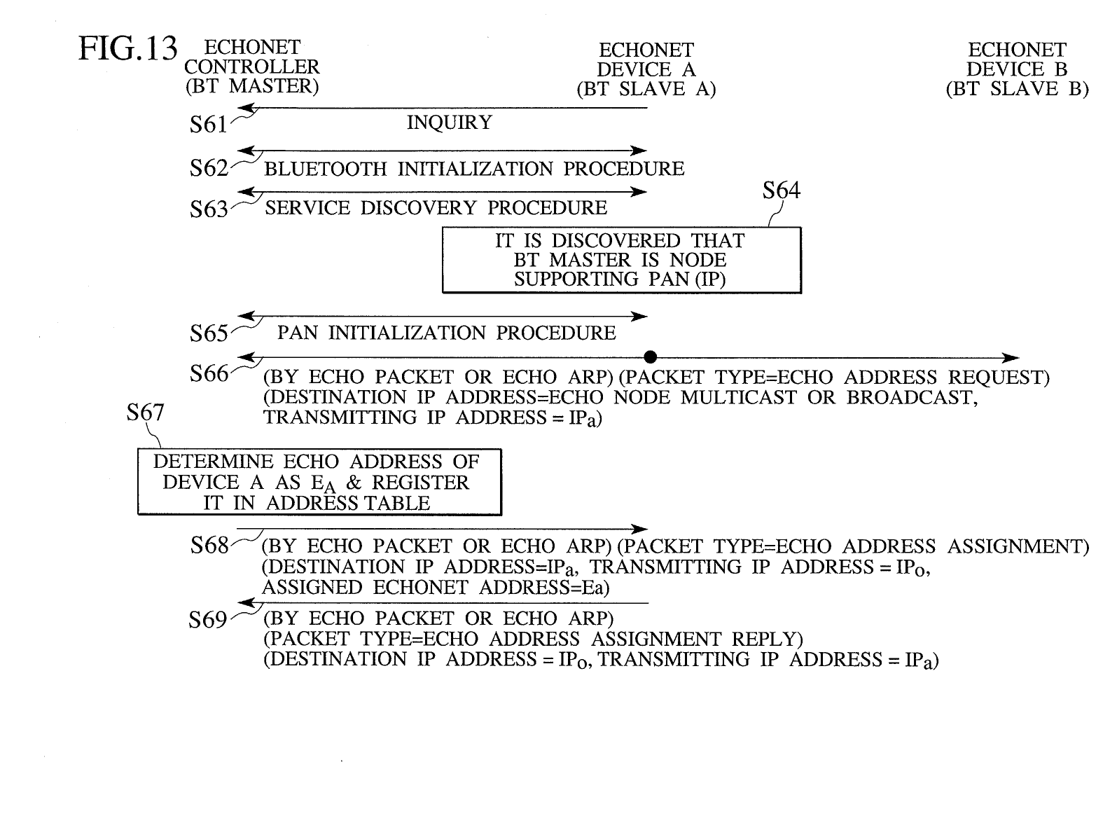

FIG. 13 shows an exemplary Echonet address initialization sequence.

In this embodiment, the Echonet device (which is assumed to be the Echonet device A) periodically sends an Inquiry to the surrounding (S61), and the Bluetooth master responds to this inquiry. In this embodiment, the Echonet controller 1 is provided on this Bluetooth master, but as already mentioned above, this is not mandatory. Upon receiving the Inquiry, the Bluetooth master carries out the master/slave conversion and the like according to the need, and places that Echonet device A under its control (S62). In the example of FIG. 10, the Echonet devices A to C are placed under its control.

Next, the service discovery procedure is carried out between the Echonet controller 1 and the Echonet device A (S63). Suppose now that the Echonet device A discovers and recognizes that the Bluetooth master is a node that supports PAN (TCP/IP) through this procedure (S64). At this point, the Echonet address of the Echonet device A is still not determined.

Next, the PAN initialization procedure is carried out between the Echonet controller 1 and the Echonet device A (S65). As a result, the TCP/IP communications using PAN are realized on the Bluetooth between these devices. This IP communication can be that of IPv4 or that of IPv6.

Next, the Echonet device A proceeds to the procedure for determining the own Echonet address. In this embodiment, the Echonet controller 1 has the “Echonet address assignment” function, and the Echonet device A requests an address to (the Echonet address assignment function of) the Echonet controller 1.

However, at this point, the Echonet device A does not know which node on the subnet is a node that can understand the Echonet protocol or which node has the Echonet address assignment function, so that the Echonet device A transmits the Echonet address request packet to this subnet (S66) by one of the following methods, for example.

The first method is a method using the broadcast. The Echonet address request packet is transmitted by using a mechanism of the IP broadcast of IPv4, or the all nodes multicast of IPv6, or the broadcast of the Bluetooth, or the broadcast of the PAN, for example.

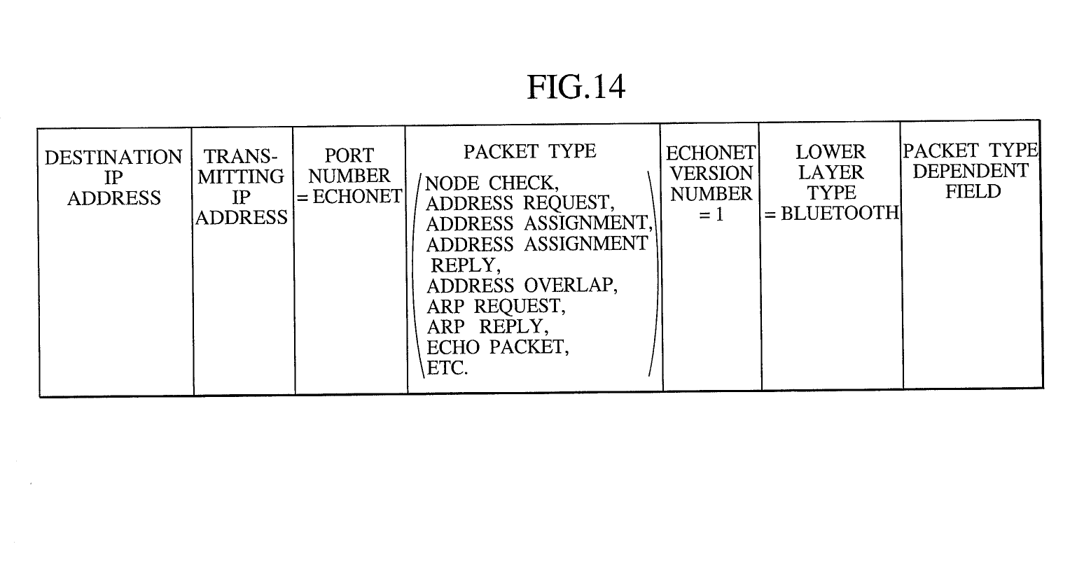

FIG. 14 shows an exemplary format of a packet to be encapsulated in the IP packet at this point. As shown in FIG. 14, apart from the general Echonet packet to be encapsulated in the IP packet, other packets such as a control packet in the case of notifying the Echonet address determination and a packet for the address resolution to be described below are also covered by this packet format.

Similarly as in the first embodiment, an “initialization sequence in the case of operating the Echonet on the IP network” that is indispensable in making the Echonet node operable, such as a check to judge whether the correspondent is an Echonet node or not, an assignment of the Echonet address, etc., is defined in this embodiment as a message of the protocol for intermediating the Echonet and the IP layer called Echonet ARP (Address Resolution Protocol).

It is also possible to map both the Echonet packet and the Echonet ARP packet to the same port number (the UDP port in this embodiment), and make it possible to distinguish whether it is the the Echonet packet or the control packet for the Echonet initialization. It is also possible to use a method for mapping the Echonet packet and the Echonet ARP packet to different port numbers.

Also, in this embodiment, the Echonet on the IP is defined in a form of “mapping onto the link local address of the IP”, but there is a future possibility for defining a new “Echonet on the Internet” by “defining the Echonet on the global IP network” or the like. In order to distinguish this “new scheme”, an Echonet version number field is provided in this embodiment, such that by entering a specific value (“1”, for example) into this field in the case of supporting the existing Echonet, it is possible to notify the destination node that “this is a packet for the Echonet communication of which version”. This field may be omitted in the case of distinguishing them by the other method or in the case where it is unnecessary to distinguish them. This provision is also applicable to the second method to be described next.

The second method is a method using the IP multicast address. this IP multicast address may be an IP multicast address assigned to the IP link local address. Either the IP multicast address assigned only to the Echonet nodes is predetermined or determined by an ad hoc algorithm in advance. When this “Echonet node multicast address” is used as the destination IP address, this packet will be transferred only to the nodes that are supporting (or scheduled to support) the Echonet protocol, so that it is possible to prevent the unnecessary transfer of the packet to the other irrelevant nodes (nodes at which the Echonet protocol is not implemented).

Note that it is also possible to construct a mechanism by which the wasteful traffic at the link level due to the transfer to the irrelevant nodes can be eliminated by mapping an address portion for several lower bits of this IP multicast address to the Ethernet address and using that as a “multicast Ethernet address”. In this case, it is possible to construct a mechanism in which the Echonet device declares the Ethernet address (the Bluetooth address assigned to the Echonet node to the Bluetooth master (the Echonet controller 1 in this embodiment) at the stage of the PAN initialization procedure of S65 in FIG. 13, such that when the Bluetooth master receives a packet (Ethernet frame) destined to the Echonet multicast address, the Bluetooth master will transfer this packet/frame only to the relevant nodes (and not transfer this packet/frame to the nodes that are not registered for the Echonet multicast address).

Now, using such a mechanism, for example, the Echonet address request packet reaches the Echonet controller 1. At the Echonet controller 1, a value of an unused Echonet address is picked up (it is assumed that a value Ea is assigned in this embodiment) by referring to the “unassigned Echonet address” shown in FIG. 12B in the address table 123, for example, and this value is registered into the address table 123 as the Echonet address of the Echonet device A (S67).

The Echonet controller 1 transmits a message loaded with the Echonet address “Ea” to be assigned to the Echonet device A using the packet type of “Echonet address assignment” to the Echonet device A (S68).

Upon receiving this message, the Echonet device A transmits the “Echonet address assignment reply” packet to the Echonet controller 1 as ACK for this message (S69).

Upon receiving this message, the Echonet controller 1 ascertains that the Echonet address “Ea” is assigned to the Echonet device A, and confirms the registration of this fact in the address table 123 provided therein (or cancel the registration if this fact cannot be ascertained). At this point, the address table 123 has registered the correspondence between the IP address and the Echonet address of the Echonet device A.

By repeating the above sequence, the assignment of the Echonet address is carried out with respect to a plurality of Echonet devices.

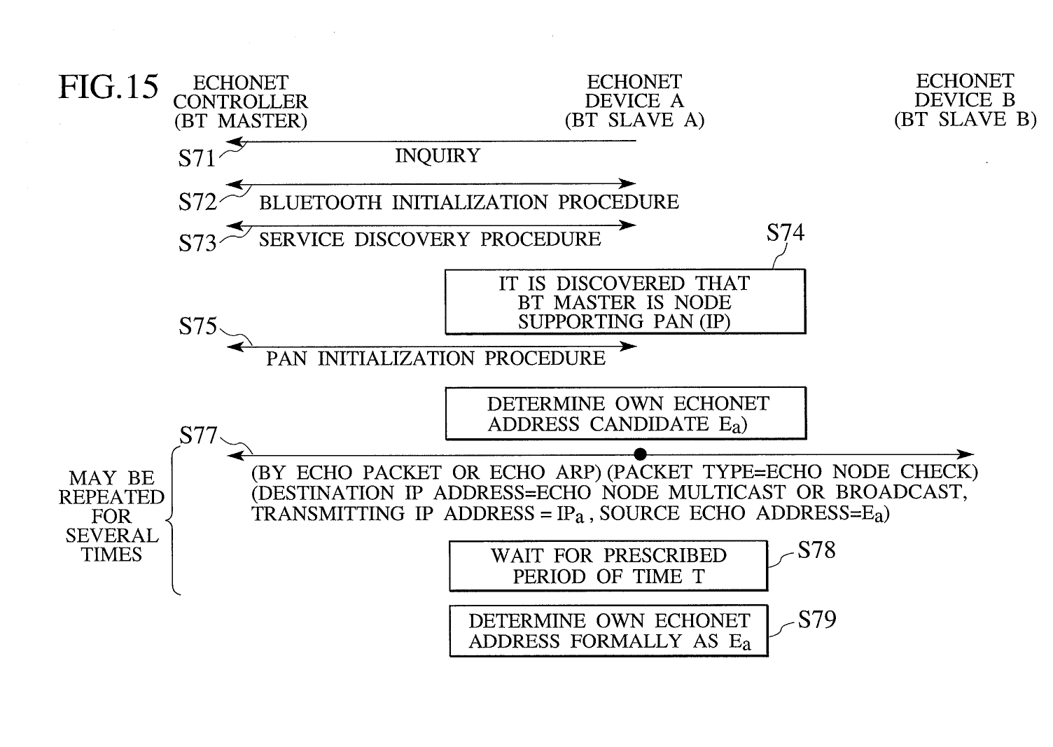

Next, FIG. 15 shows another exemplary overall sequence for the case where the Echonet device 3 joins the IP subnet, the Echonet address is assigned, and the correspondence among addresses is established.

In the example of FIG. 15, each Echonet device 3 determines the Echonet address by the Echonet device itself rather than assuming the existence of a “server that determines the Echonet address on behalf of the Echonet device” somewhere on the network.

Namely, the Echonet device (which is assumed to be the Echonet device A) itself determines an “Echonet address candidate” somehow (by the method to be described below, for example) (S76), and broadcasts this Echonet address candidate to that subnet (S77). This broadcast can be transmitted by using the link local IP broadcast (the all nodes multicast in the IPv6) or by using the IP multicast address (or the link local address) assigned to the Echonet nodes.

If there is no reply during a certain period of time T after transmitting this Echo node check packet, the Echonet device A judges that there is no other node which has the same Echonet address in that subnet, and determines to use that address as the Echonet address of this node (S79).

Note that it is also possible to determine the use of that address when there is no reply even after repeating the steps S77 and S78 for a prescribed number (plurality) of times.

Also, when there is a reply during the prescribed period of time, the steps S76 to S78 can be repeated while changing the Echonet address candidate at the step S76 until the use of the address is determined at the step S79.

There are various methods for determining a value of the “Echonet address candidate (to be determined by the Echonet device itself”. For example, it is possible to use a value such as:

the own link layer address (the AM_ADDR value of the Bluetooth or several lower bits of the Bluetooth address);

a value of some timer or clock within the Echonet device itself at that point; or

an output result of a random number generator.

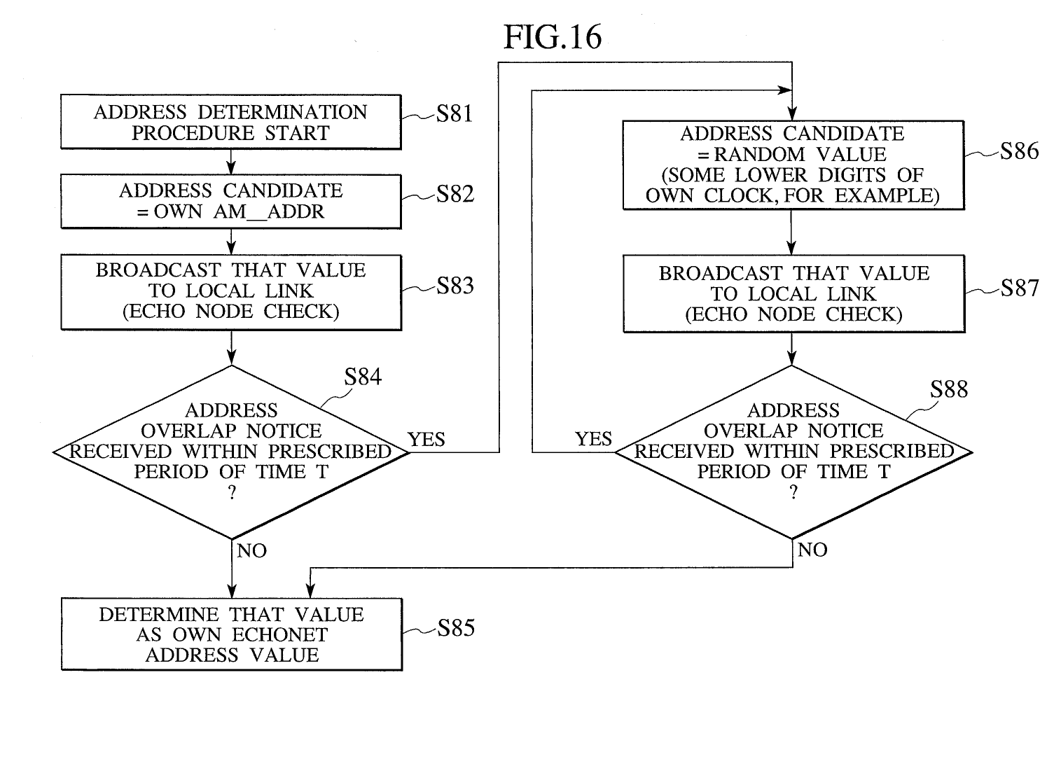

FIG. 16 shows an exemplary flow chart for the Echonet address determination procedure.

In the Example of FIG. 16, when the address determination procedure is started (S81), the Echonet device 3 first determines the address candidate (such as the own Bluetooth active mode address AM_ADDR, for example) (S82), and broadcasts the determined address candidate value to the local link in order to check whether there is the other node that is using the same address or not (S83).

Then, if there is no address overlap notice within a prescribed period of time T (S84), that address candidate value is determined as the own Echonet address value (S85).

On the other hand, if there is an address overlap notice within a prescribed period of time T (S84), another address candidate is determined randomly (for example, it is determined as a value indicated by several lower digits of the clock within the Echonet device) (S86), and broadcasts the determined address candidate value to the local link again in order to check whether there is the other node that is using the same address or not (S87).

Here, if there is no address overlap notice within a prescribed period of time T (S88), that address candidate value is determined as the own Echonet address value (S85).

Also, if there is an address overlap notice within a prescribed period of time T (S84), the steps S86 to S88 are repeated to obtain the address not used by the other node.

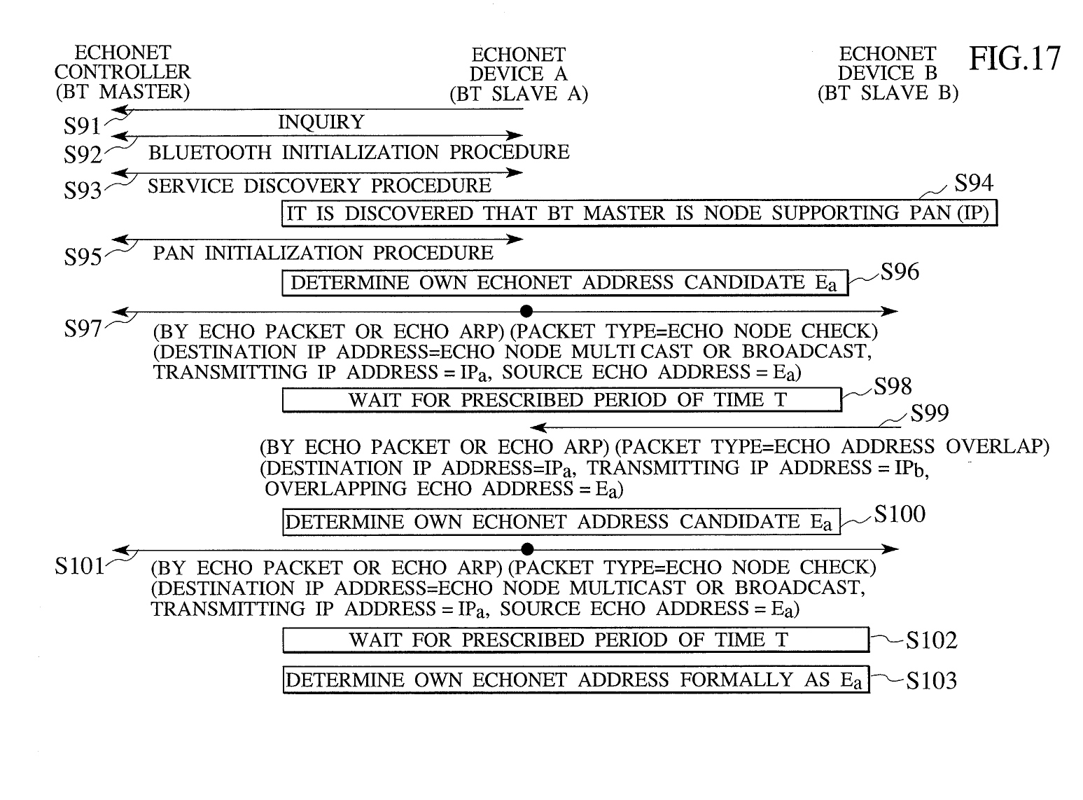

Here, FIG. 17 shows an exemplary concrete sequence in the case where the Echonet address value that the Echonet device A attempted to assign to itself is already used by the Echonet device B. In FIG. 17, a message indicating “that Echonet address value is already used by this device” is notified as an Echonet address overlap message (S99).

Now, after the Echonet address is determined at the step S79, the exchange of the Echonet packet is carried out between the Echonet nodes in a form of encapsulating the Echonet packet into the IP packet.

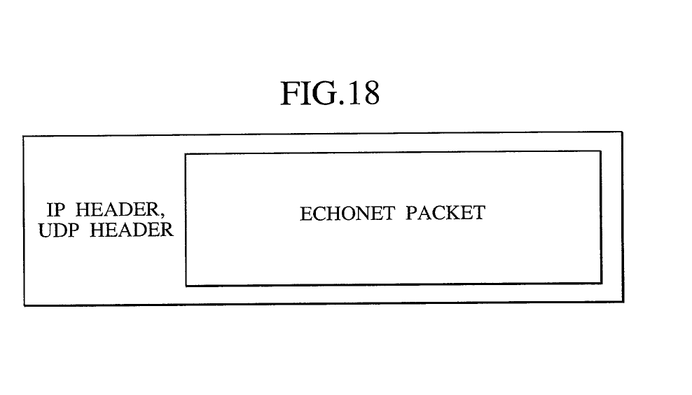

In this embodiment, as described above, the Echonet packet is encapsulated into the UDP packet. FIG. 18 shows a form of the Echonet packet as encapsulated in the UDP packet.

Next, the address resolution in this embodiment will be described.

When the Echonet device A has a packet destined to the Echonet device B, there can be a case where it is possible to ascertain its destination Echonet address but it is impossible to ascertain the destination IP address. In such a case, there is a need to carry out the address resolution.

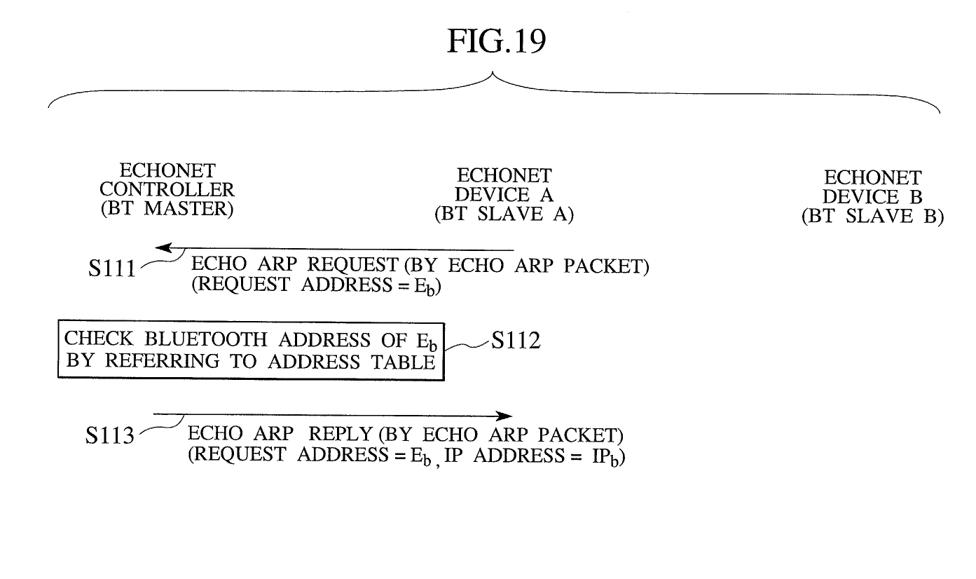

FIG. 19 shows one exemplary sequence for the address resolution.

FIG. 19 is directed to the case where the Echonet controller (the Bluetooth master) 1 becomes the address resolution server and resolves the address by referring to the address table 123 provided therein.

The Echonet controller 1 is an appropriate selection as an address resolution target because it is usually expected to be recognizing the existence of all the Echonet nodes in that subnet.

For example, when the Echonet device A wishes to resolve the IP address of the Echonet device B from the Echonet address of the Echonet device B, the Echonet ARP request packet is transmitted in a form of the unicast packet to the Echonet controller 1 (S111). At that point, “Eb” is attached as the address whose resolution is requested.

Upon receiving this packet, the Echonet controller 1 checks the IP address of “Eb” by referring to the address table 123 provided therein (S112), and ascertains that it is “IPb”.

The Echonet controller 1 then returns the IP address “IPb” of the Echonet device B as the Echonet ARP reply (S113).

Thereafter, when there is a packet destined to the Echonet device B, the Echonet device A transmits the IP packet with the destination IP address “IPb” to the Echonet controller 1. In this way, the communications between arbitrary Echonet devices can be realized.

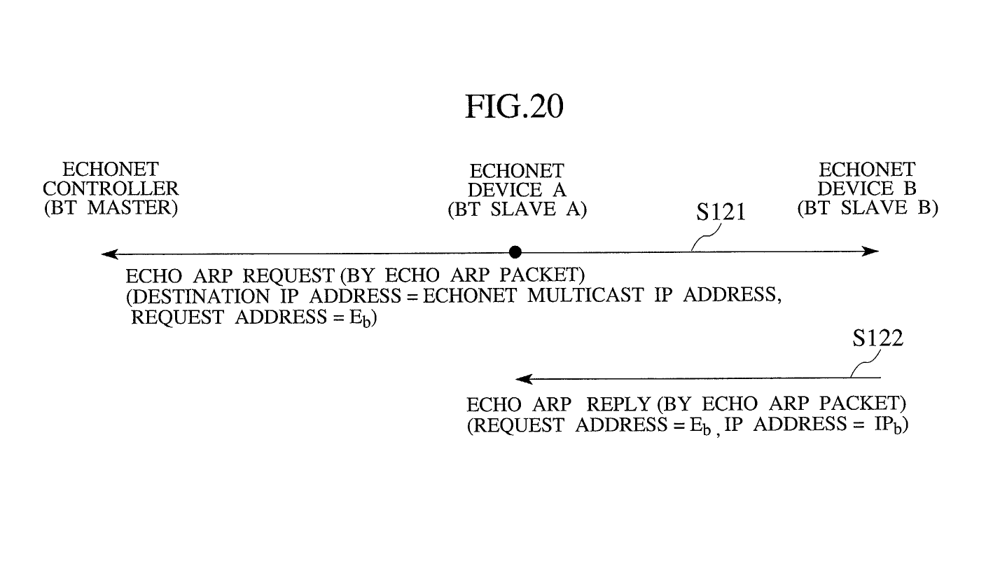

Next, FIG. 20 shows another exemplary sequence for the address resolution.

FIG. 20 is directed to the case where there in no server that will carry out the address resolution on behalf of the subnet. It is possible to consider the method for broadcasting the address resolution request inside that subnet, but in this embodiment, this is transmitted to the above described IP multicast address (which can be either that of IPv4 or that of IPv6) assigned to the Echonet nodes (S121). Upon receiving this request, the Echonet device B returns the own IP address “IPb” as the Echonet ARP reply (S122). In this way, this IP multicast packet will not reach the nodes irrelevant to the Echonet so that it is possible to prevent the flow of the unnecessary traffic.

Note that, in the embodiments described above, the Echonet protocol is used as a protocol for controlling devices connected to the network, but the present invention is not limited to this specific case and also applicable to the other various control protocols.

Also, in the above, the exemplary cases of using the Bluetooth or the IP (IP over Bluetooth) as the local area network, but the present invention is also applicable to the networks in the other schemes.

Also, in the above, the exemplary case of using the home network as the local area network, but the present invention is also applicable to the other local area network such as intranet.

As described, according to the present invention, it is possible to enable the operation of a control protocol such as Echonet on networks such Bluetooth, IP, etc.

It is to be noted that the above described embodiments according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the cash dispenser terminal or the cash dispenser device of each of the above described embodiments can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A communication control device for carrying out a communication control to support communications by a prescribed control protocol on a prescribed network with respect to a communication device having a function for accessing a prescribed network, the communication control device comprising:
an interface unit configured to access the prescribed network;
a control protocol processing unit configured to carry out a processing regarding data of the prescribed control protocol to be transmitted/received through the prescribed network;
a memory unit configured to store in correspondence a first address information to be used in the prescribed network which is uniquely assigned to the communication device, an identification information to be assigned to the communication device by the communication control device for enabling identification of a logical connection in the prescribed network, and a second address information to be used by the prescribed control protocol which is assigned to the communication device by the communication control device, for each communication device connected to the prescribed network; and
a routing processing unit configured to send data received through the prescribed network to the control protocol processing unit when received data are the data of the prescribed control protocol and a destination address of the received data is the communication control device, or obtain the identification information stored in the memory unit by using the destination address as the first address information and transmit the received data to the destination address through the logical connection in the prescribed network as specified by the identification information when the destination address is the communication device.

2. The communication control device of claim 1, further comprising an Ethernet frame transmission/reception unit configured to carry out transmission/reception of Ethernet frames, wherein transmission/reception of the data of the prescribed control protocol is carried out on Ethernet frames.

3. The communication control device of claim 2, wherein the Ethernet frame transmission/reception unit is contained in the routing processing unit, and the data of the prescribed control protocol is a packet of the prescribed control protocol encapsulated in an Ethernet frame.

4. The communication control device of claim 1, further comprising an initialization processing unit configured to carry out an initialization processing to assign the second address information that is not assigned at that point to the communication device by referring to the memory unit, and notify an assigned second address information to the communication device, upon receiving a request message for requesting an assignment of the second address information from the communication device connected to the prescribed network.

5. The communication control device of claim 4, further comprising a transmission unit configured to transmit an inquiry message for inquiring whether the communication device is supporting the prescribed control protocol or not with respect to the communication device connected to the prescribed network,
wherein the request message is transmitted by the communication device in response to the inquiry message.

6. The communication control device of claim 4, further comprising a transmission unit configured to transmit a notification message for notifying that the communication control device is supporting the prescribed control protocol to the communication device, upon receiving an inquiry message for inquiring whether the communication control device is supporting the prescribed control protocol or not from the communication device connected to the prescribed network,
wherein the request message is transmitted by the communication device in response to the notification message

7. The communication control device of claim 4, wherein transmission/reception of messages for an initialization of the prescribed control protocol is carried out by using messages attached with a protocol identifier that is different from a specific protocol identifier indicating the prescribed control protocol.

8. The communication control device of claim 7, wherein the transmission/reception of messages for the initialization of the prescribed control protocol is carried out by using messages attached with an information indicating physical transfer medium.

9. The communication control device of claim 1, further comprising an address resolution unit configured to receive a message containing the second address information of another communication device connected to the prescribed network and requesting an address resolution into the first address information from one communication device connected to the prescribed network, and transmit an address resolution reply message containing the first address information of the another communication device by referring to the memory unit to the one communication device.

10. The communication control device of claim 1, wherein the interface unit is configured to access the prescribed network which is a Bluetooth.

11. The communication control device of claim 10, wherein the memory unit is configured to store the first address information which is a Bluetooth address of the Bluetooth, and the identification information which is a slave identifier of the Bluetooth.

12. The communication control device of claim 10, wherein the memory unit is configured to store the identification information for enabling identification of the logical connection which is an L2CAP channel of the Bluetooth.

13. The communication control device of claim 1, wherein the control protocol processing unit is configured to carry out the processing regarding data of the prescribed control protocol which is an Echonet protocol.

14. The communication control device of claim 13, wherein the memory unit is configured to store the second address information which is an Echonet address.

15. A communication control method of a communication control device for carrying out a communication control to support communications by a prescribed control protocol on a prescribed network with respect to a communication device having a function for accessing a prescribed network, the communication control method comprising:
storing in correspondence a first address information to be used in the prescribed network which is uniquely assigned to the communication device, an identification information to be assigned to the communication device by the communication control device for enabling identification of a logical connection in the prescribed network, and a second address information to be used by the prescribed control protocol which is assigned to the communication device by the communication control device, for each communication device connected to the prescribed network, as an address table; and
sending data received through the prescribed network to a control protocol processor for carrying out a processing regarding data of the prescribed control protocol when received data are the data of the prescribed control protocol and a destination address of the received data is the communication control device, or obtaining the identification information stored in the address table by using the destination address as the first address information and transmitting the received data to the destination address through the logical connection in the prescribed network as specified by the identification information when the destination address is the communication device.

16. A computer program product for causing a computer to function as a communication control device for carrying out a communication control to support communications by a prescribed control protocol on a prescribed network with respect to a communication device having a function for accessing a prescribed network, the computer program product comprising:
a first computer program code for causing the computer to provide an interface function for accessing the prescribed network;
a second computer program code for causing the computer to provide a control protocol processing function for carrying out a processing regarding data of the prescribed control protocol to be transmitted/received through the prescribed network;
a third computer program code for causing the computer to provide a memory function for storing in correspondence a first address information to be used in the prescribed network which is uniquely assigned to the communication device, an identification information to be assigned to the communication device by the communication control device for enabling identification of a logical connection in the prescribed network, and a second address information to be used by the prescribed control protocol which is assigned to the communication device by the communication control device, for each communication device connected to the prescribed network; and
a fourth computer program code for causing the computer to provide a routing processing function for sending data received through the prescribed network to the control protocol processing function when received data are the data of the prescribed control protocol and a destination address of the received data is the communication control device, or obtaining the identification information stored by the memory function by using the destination address as the first address information and transmitting the received data to the destination address through the logical connection in the prescribed network as specified by the identification information when the destination address is the communication device.

17. A communication device for carrying out communications by a prescribed control protocol on a prescribed network of a prescribed network layer protocol, comprising:
an interface unit configured to access the prescribed network;
a control protocol processing unit configured to carry out a processing regarding data of the prescribed control protocol to be transmitted/received through the prescribed network;
a memory unit configured to store in correspondence a network layer address with an address scope set to be link local which is to be used by each communication device in the prescribed network and a prescribed address to be used in the prescribed control protocol by each communication device, for each one of the communication device and other communication devices connected to the prescribed network; and
a transmission/reception unit configured to carry out transmission/reception of a specific packet of the prescribed network layer protocol in which a packet of the prescribed control protocol is encapsulated, by using link local addresses as a destination network layer address and a source network layer address of the specific packet, according to the memory unit.

18. The communication device of claim 17, further comprising an initialization processing unit configured to carry out an initialization processing to assign an address that is not assigned at that point by referring to the memory unit, and notify an assigned address to another communication device, upon receiving an address request packet for requesting an assignment of a prescribed address to be used in the prescribed control protocol by the another communication device, from the another communication device connected to the prescribed network, the address request packet being destined to a link local multicast network layer address assigned only to those communication devices which have the prescribed control protocol.

19. The communication device of claim 17, further comprising an initialization processing unit configured to transmit an address request packet for requesting an assignment of a prescribed address to be used in the prescribed control protocol by the communication device, to another communication device connected to the prescribed network, and receive and process an address notification packet for notifying an address assigned by the another communication device, the address notification packet being destined to a link local multicast network layer address assigned only to those communication devices which have the prescribed control protocol.

20. The communication device of claim 17, further comprising an initialization processing unit configured to check absence of another communication device which has an identical address on a local link by carrying out a series of processing for a prescribed number of times and determine a tentatively assigned address for which absence of the another communication device is checked as the prescribed address to be used in the prescribed control protocol by the communication unit, the series of processing being a processing for tentatively assigning one prescribed address to be used in the prescribed control protocol by the communication device, transmitting an address check packet for asking a returning of a reply to the communication device if a tentatively assigned address is already assigned, by using a link local multicast network layer address assigned only to those communication devices which have the prescribed control protocol, and checking absence of the reply with respect to the address check packet for a prescribed period of time after transmitting the address check packet.

21. The communication device of claim 17, wherein the interface unit has a Bluetooth interface as a physical transfer medium for the specific packet, and the transmission/reception unit is configured to transmit/receive the specific packet having a field for indicating that the physical transfer medium is a Bluetooth.

22. The communication device of claim 17, wherein the transmission/reception unit is configured to transmit/receive the specific packet having a field for indicating a version number of the prescribed control protocol.

23. The communication device of claim 17, wherein the interface unit has a Bluetooth interface as a physical transfer medium for the specific packet, and the communication device further comprises an address resolution unit configured to transmit a request packet containing the prescribed address to be used in the prescribed control protocol by one communication device connected to a Bluetooth and requesting an address resolution into a network layer address of the one communication device, to another communication device connected to the Bluetooth which is a controller in the prescribed control protocol existing on a local link.

24. The communication device of claim 17, wherein the interface unit is configured to access the prescribed network of the prescribed network layer protocol which is an Internet protocol, and the memory unit is configured to store the network layer address which is an IP address.

25. The communication device of claim 17, wherein the control protocol processing unit is configured to carry out the processing regarding data of the prescribed control protocol which is an Echonet protocol.

26. The communication device of claim 25, wherein the memory unit is configured to store the prescribed address which is an Echonet address.

27. A communication method of a communication device for carrying out communications by a prescribed control protocol on a prescribed network of a prescribed network layer protocol, the communication method comprising:
storing in correspondence a network layer address with an address scope set to be link local which is to be used by each communication device in the prescribed network and a prescribed address to be used in the prescribed control protocol by each communication device, for each one of the communication device and other communication devices connected to the prescribed network, as an address table;
carrying out transmission/reception of a specific packet of the prescribed network layer protocol in which a packet of the prescribed control protocol is encapsulated, by using link local addresses as a destination network layer address and a source network layer address of the specific packet according to the address table.

28. A computer program product for causing a computer to function as a communication device for carrying out communications by a prescribed control protocol on a prescribed network of a prescribed network layer protocol, the computer program product comprising:
a first computer program code for causing the computer to provide an interface function for accessing the prescribed network;
a second computer program code for causing the computer to provide a control protocol processing function for carrying out a processing regarding data of the prescribed control protocol to be transmitted/received through the prescribed network;
a third computer program code for causing the computer to provide a memory function for storing in correspondence a network layer address with an address scope set to be link local which is to be used by each communication device in the prescribed network and a prescribed address to be used in the prescribed control protocol by each communication device, for each one of the communication device and other communication devices connected to the prescribed network; and
a fourth computer program code for causing the computer to provide a transmission/reception function for carrying out transmission/reception of a specific packet of the prescribed network layer protocol in which a packet of the prescribed control protocol is encapsulated, by using link local addresses as a destination network layer address and a source network layer address of the specific packet, according to the memory function.
